(19) United States
(12) Patent Application Publication
(10) Pub. No.: US 2004/0199274 A1
(43) Pub. Date: Oct. 7, 2004

(54) Device for operation and observation, having a fast input keypad

(75) Inventors: Michael Hegmann, Nuernberg (DE); Mario Koerner, Erlangen (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/752,534

(22) Filed: Jan. 8, 2004

(30) Foreign Application Priority Data
Jan. 10, 2003 (DE) 20300256.3
Aug. 28, 2003 (DE) 20313453.2

(51) Int. Cl. G06F 13/12; G05B 15/00

(52) U.S. Cl. 700/83; 710/67

(57) ABSTRACT

The HMI (human machine interface) device is used for observing and operating an industrial process. It contains a display element (B) at least for process variables (PW) and at least one keypad (TV). At least one key (TV2) of the keypad (TV) is assigned a group of characters (a, b, c, 2, ä, à, æ, å, [symbol] ). A processing unit (VE) displays another character (2) from the group of assigned characters (a, b, c, 2, . . . ) on the display element (B) in a process variable (PW) for each time the key (TV2) of the keypad (TV) is operated. The processing unit (VE) records, as the current input character (PWS), that character (2) from the group that has been displayed for a predetermined period of time before the key (TV2) is operated anew.

The following disclosure is based on German Patent Application Nos. 20300256.3 and 20313453.2, filed on Jan. 10, 2003 and Aug. 28, 2003, respectively, which are incorporated into this application by reference.

### FIELD OF AND BACKGROUND OF THE INVENTION

This invention relates to an HMI (human-machine interface) device for observation and operation of an industrial process.

Industrial equipment is controlled with the help of programmable digital data processing systems. Industrial equipment is understood to refer to any type of industrial equipment and systems installed individually as well as in a data network, e.g., via a field bus. In the case of industrial use, industrial equipment is understood to include individual operating devices such as drives, machine tools, intelligent detecting elements, sensors and the like. However, industrial equipment may also include an entire production installation in which an entire industrial process is carried out with locally distributed operating facilities, e.g., a chemical plant, a manufacturing line or a processing installation.

Industrial equipment is controlled and operated by means of digital programmable data processing systems which are often designed as automation systems or a part thereof. Automation systems here have special devices which form the interface between an operator and the system. Such equipment is known as HMI equipment, i.e., human-machine interface. In addition these devices are also referred to as equipment for “operation and observation” of industrial equipment, abbreviated as “O & O equipment.” This equipment is installed upstream from the equipment used for direct control of the industrial installation, e.g., the “PLC” (programmable logic controllers). This relieves the burden on the central control installation, e.g., a stored program control SPC.

The term HMI device is understood to be an umbrella term which also includes all the components belonging to this group of devices. Examples of such components include, for example, operator panels, often referred to simply as “OP” and industrial personal computers IPC which are used as HMI devices and/or associated programming devices. Because of their special functionality, HMI devices are responsible for functions which can be regarded in general as presentation and post-processing of data of the industrial installation to be controlled, e.g., in a network automation system. This function is referred to as “supervisor control and data acquisition” (SCADA). To this end, special software is executed by an HMI device. This software provides functions that improve the convenience, quality and reliability of operation by an operator e.g., providing an overview of the installation to be operated and error-free operation. Thus, for example, interactive process images of the industrial installation to be operated can be displayed and operated via HMI equipment, but they can also be designed and generated with this equipment. This permits, first of all, a selective display of reactions of the industrial installation, usually in the form of measured values and messages. On the other hand, it is possible, through targeted specification of operator actions, to convert the industrial equipment to the desired states. In addition to these “observation and operation” functions, installation-specific design is also possible using an HMI device, e.g., designing interactive process images.

For the tasks indicated above, an operator must regularly perform a large number of data entries. To do so, HMI devices have fields of input keys which may be implemented, for example, either in the form of splash-proof microswitches or in software form as a virtual keyboard on a touchscreen. Especially in the embodiment of an HMI device in the form of an operator panel, its front panel is often equipped with a plurality of input keys.

FIG. 1 shows a front view of a known HMI device designed as an operator panel, by way of example. The operator panel is countersunk in a work surface, e.g., in a switching cabinet, so that the front panel FBP of the operator panel rests on the surrounding work surface at its edges. The front panel FBP has a display element B, e.g., an LCD unit or a touchscreen. For example, process messages, dynamic process overview charts, measured values, etc., can be displayed on this screen. In FIG. 1, for example, a process variable PW, which represents the setpoint of a controlled variable 20 is displayed. This is currently set at “1450.” During operation of an industrial process, it is regularly necessary to adapt the setpoint values to altered operating conditions. For example it may be necessary to slightly increase or reduce a setpoint value or to reformulate the text of a message. Input keys are available for the operator to perform such alphanumeric entries. To limit the number of keys on the front panel FBP, it has become customary to assign more than one character to an input key.

In the example of FIG. 1, several fields of input keys are provided. For example, the 3×4 input keys in a first field TE11 have multiple assignments with alphanumeric characters and are thus used for both numeric input and text input. The field TE11 is supplemented by a second field TE12 of 1×4 input keys at the side of the former, its keys also having multiple assignments with special keys and letters. Finally, a third field TE2 with 1×4 input keys and also a fourth field TE3 with 1×3 input keys are provided. Their keys are assigned to special characters and standard editing functions, e.g., the TAB and DEL functions.

In the known embodiment depicted in FIG. 1, the multiple occupancy of the keys in the keypads TE11, TE12, TE2, TE3 is structured in logic levels. For example, in FIG. 1 the characters shown in black are in a first logic level and the characters shown in white at the upper left and upper right of a key are in a second and third level, respectively. In the example shown in FIG. 1, a desired logic level is activated by a shift key TEU, which is positioned at the lower left corner of the front panel FBP. By successive operation of the shift key TEU, an operator is able to activate the individual logic levels and thus enable the input of numerals 0, 1, 2, . . . or the input of letters from a first group A, C, E, . . . or the input of letters from a second group B, D, F, . . . . In addition, the operator is able to determine which of the logic levels is active at the moment in the input keypads TE11, TE12, TE2, TE3 on the basis of light spots mounted on status displays in the upper left and upper right of the shift key TEU labeled as “AZ.”

The known embodiment of an HMI device depicted in FIG. 1 has the disadvantage that an operator must switch frequently between the logic levels described above when performing data entry via the keypads. This affects in particular the input of strings of alphanumeric characters, which is necessary when editing message text. Thus, self-contained input of strings of alphanumeric characters in one stroke, so to speak, is not possible. Instead, it is necessary to switch constantly between the logic levels. This requires a high level of attention on the part of an operator, because it requires constant visual comparison between the assignment of the character being input at the moment and the respective logic level plus the instantaneous status of the shift key TEU.

In addition to the fields of input keys described above, the known HMI device depicted in FIG. 1 also has a first field TF1 of freely programmable function keys F1, F3, F5, F7 at the left of the display element B, a second field TF2 of freely programmable function keys F2, F4, F6, F8 to the right of the display element B and a third field TF3 of freely programmable function keys F9-F14, K1-K10 below the display element B. In addition, there is also a first field TS1 of control keys, e.g., for cursor control, a second field TS2 of control fields, e.g., assigned to the control functions HELP, ESC, ACK and a third field TS3 of control keys, e.g., assigned to the control functions SHIFT, CTRL, ALT. Finally, an acknowledgment key TSE, which is labeled as ENTER, is provided in the lower right corner of the front panel FBP. The logic levels assigned to the input keys and the further data processing of entries performed via these input keys are managed by a program-control processing unit, which is accommodated in a housing behind the front panel FBP and is symbolized by the reference notation VE in FIG. 1.

### OBJECTS OF THE INVENTION

One object of this invention is to provide an HMI device of the general type described in the example of FIG. 1, so that input of strings of alphanumeric characters by operators using input keys having multiple character assignments can be performed with a lowered level of visual attention.

### SUMMARY OF THE INVENTION

This and other objects are achieved, according to one formulation of the invention, with an HMI device configured to observe and/or operate an industrial process. It contains a display element at least for process variables and at least one keypad. At least one key of the keypad is assigned a group of characters. Each time the key on the keypad is operated, a processing unit displays in a process variable a different character from the group of characters assigned to that key on the display element. In addition, the processing unit records the character from the group—as the current input character—which has been displayed for a predetermined period of time before the key is operated anew.

This invention has the advantage that, in the case of an HMI device, each single key on the keypad is assigned a respective group of characters which are linked together operationally and are logically equivalent. Each key thus represents an autarkic input unit for the respective group of characters assigned to it. This eliminates the need to connect different keys operationally through overreaching logic character levels and, as such, greatly ameliorates the associated visual attention problems experienced by users. Thus, with this device, input techniques that have already been introduced in other, different commercial areas of the industry for inputting characters, e.g., on cell phones, is thus also utilized in the industrial environment. This is advantageous in particular with HMI devices which constitute the interface between an operator and the technical systems used to observe and control an industrial process.

### BRIEF DESCRIPTION OF THE DRAWINGS

Embodiments and advantageous refinements of the inventive HMI device and associated systems are described in greater detail below. In conjunction with the descriptions given above and below:

FIG. 1 shows a related, conventional HMI device, as already explained above, and

FIG. 2 shows a preferred embodiment of an HMI device designed according to this invention, shown in a plan view.

### DETAILED DESCRIPTION OF PREFERRED EMBODIMENTS

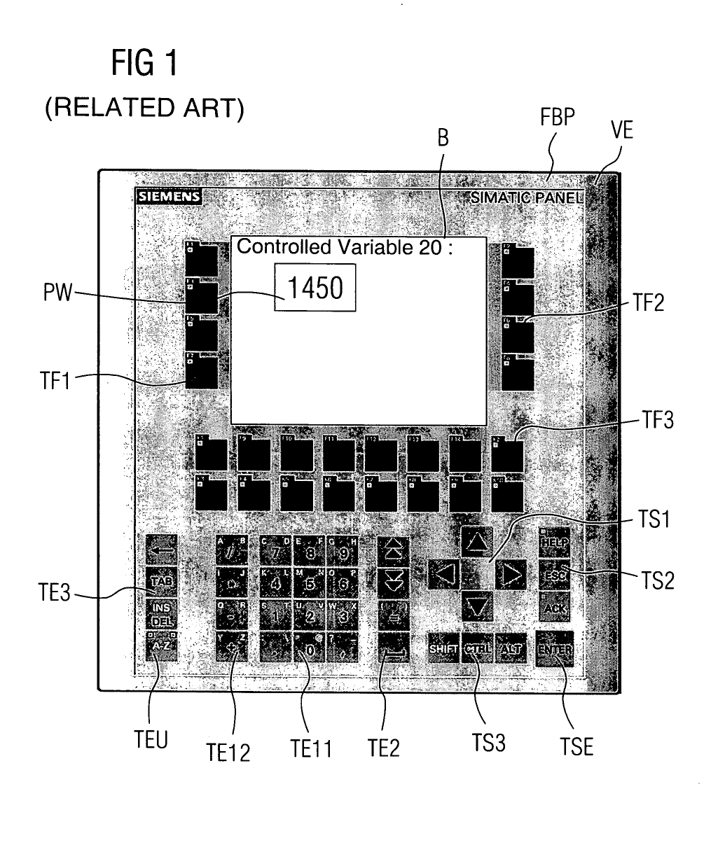

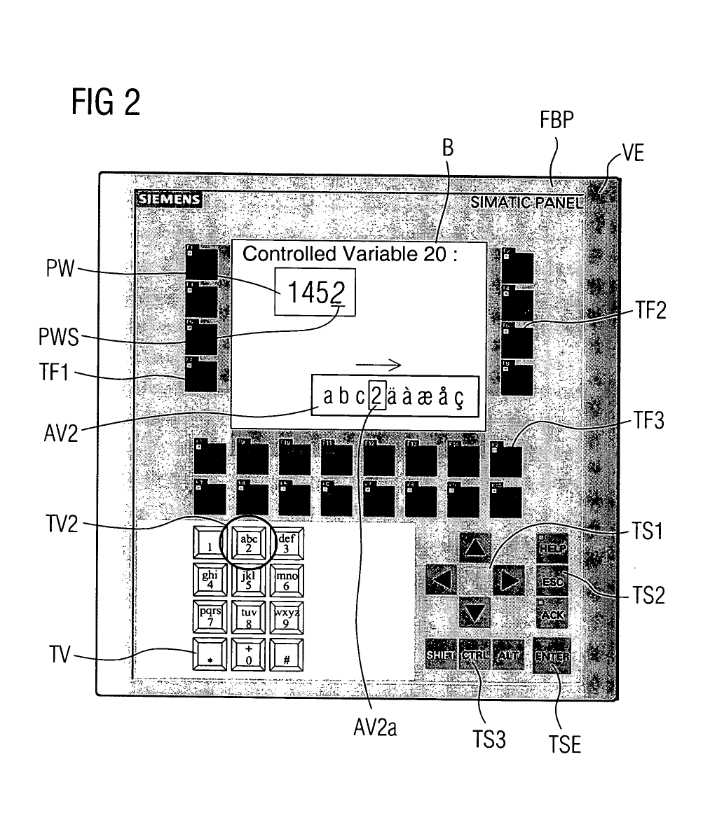

An advantageous embodiment of an HMI device designed according to this invention as shown in FIG. 2 is comparable to the HMI device in FIG. 1. For reasons of simplicity, reference is therefore made to the discussion of FIG. 1 for parts having the same reference notation. However, the fields of input keys TE11, TE12, TE2, TE3 which are used in the embodiment in FIG. 1 are replaced, according to this invention, by a single field TV with rapid input keys, as shown in the embodiment in FIG. 2. Each key of the field is assigned a group of characters. The characters may be retrieved in sequence by repeated actuation of the key. This will be explained, with reference, by way of example, to the key TV2, which is also representative of the other keys of the field.

The key TV2 of the keypad TV is assigned, for example, the group of characters a, b, c, 2, ä, à, æ, å, [symbol] . Of course, the key may also be assigned any other string of characters, which may have a different makeup and may be either smaller or greater. For each operation of the key TV2 of the rapid input keypad TV, the processing unit VE brings up another character from the group of assigned characters a, b, c, 2, ä, à, æ, å, [symbol] for display on the display element B and records the character from the group as the current input character which has been displayed for a certain period of time before further actuation of the key TV2 is stopped. Thus, in the case of the situation depicted in FIG. 2, the character 2 from the group of assigned characters has just been displayed on the display element B in the process variable PW.

This case may occur in practice, for example, when an operator must increase the setpoint value for the controlled variable 20, which has the value “1450” according to FIG. 1, to “1452.” To do so, the operator advantageously makes an insertion mark at the corresponding position in the field of the process variable PW and activates the number 2 by repeated actuation of the key TV2. It is advantageous if, during operation of the keyboard, all the assigned characters a, b, c, 2, ä, à, æ, å, [symbol] are additionally displayed on the display element B in a separate window AV2, and if the character active at the moment is shown there highlighted in some fashion. In the example shown here, an operator must consequently depress the key TV2 at least four times to change from the character “a” to the character “b” and then “c” to reach the desired character “2” from the group. The processing unit VE records the character 2 from the group as the current input character PWS in the process variable PW when there is no further operation of the key TV2 and the character “2” remains displayed for a predetermined period of time.

An HMI device according to the present invention may be designed as a stationary operator panel or advantageously also as a mobile hand-held terminal for machine operation and machine monitoring. The present invention thus offers the advantage that an operator employed in an industrial plant need not pay undue attention to special operator manipulations during this activity. Rather, the operator is able to use, in the industrial environment, operations of rapid-input keypads, with which he may already be familiar from the private sector, e.g. from operating a cell phone.

Another embodiment of this invention not shown separately in the figures provides the display element B of the HMI device designed as a touchscreen. In such a case, the keypad TV is not provided in discrete form but instead is simulated as a screen mask based on software.

In addition, an automation system that manipulates an industrial machine may have at least one connected or integrated HMI device according to this invention.

In yet another embodiment of this invention, the processing unit VE of the HMI device is additionally equipped with a text analyzer that accesses one or more text indices, which may, if desired, also be in a foreign language or in multiple languages. The text analysis function is triggered when an operator operates a key in the keypad to perform an input. The characters from the group assigned to the key together with any related input characters that might already be present are then checked for at least partial matches to entries in the text index. If entries with a high degree of correspondence are found in this check, these entries are output on the display element as a possible string of input characters.

In the design and/or operation and observation of industrial installations, such a technique constitutes a considerable improvement in operating quality in particular. These text indices can be coordinated to advantage with the vocabulary required in the operation and observation of industrial installations as well as the required symbols. It is even possible to create text indices and load them into the inventive HMI device, with these text indices being coordinated specifically with the terms required and/or present in a certain industrial installation or a certain type of installation.

This embodiment facilitates the operation for an operator. If, after incomplete input by the operator, the string of input characters proposed on the display element is accepted, then no further entries are necessary. In addition, an operator may reduce the frequency of operating a key by accessing the input character strings proposed by the text analyzer instead of activating the other characters from the assigned group of characters by additional operations of a key.

However, a particular advantage lies in industrial use, where a standardization can be achieved in the input of text through the use of text indices that are specific for a certain installation, model or sector. In this embodiment of the invention, there is a definite increase in the probability that an operator will accept as input a string of input characters proposed by the processing unit and will thus rely on a term from the text list that has been prefabricated technologically or in a plant-specific manner.

Input of the word “drive” via the keypad TV of the HMI device depicted in FIG. 2 will now be used as an example. By using the above embodiment of this invention, one need only operate the keys with the numbers 3, 7, 4, 8 and 3, respectively, to enter this word. If the desired word “drive” is stored in a technological or installation-specific text index, the text analyzer can recognize automatically, e.g., on operation of key 7, that the letter “r” has a meaning from the group of characters “p,”, “q”, “r” and “s” assigned to this key and that it has a high degree of correspondence with the word “drive”.

The above description of the preferred embodiments has been given by way of example. From the disclosure given, those skilled in the art will not only understand the present invention and its attendant advantages, but will also find apparent various changes and modifications to the structures and methods disclosed It is sought, therefore, to cover all such changes and modifications as fall within the spirit and scope of the invention, as defined by the appended claims, and equivalents thereof.

What is claimed is:

1. An HMI device for observation and operation of an industrial process, comprising:
a) a display element at least for process variables,
b) at least one keypad, a group of characters being assigned to a key of the keypad, and
c) a processing unit, which:
c1) displays a different character from the group of the assigned characters on the display element in a process variable each time the key of the keypad is operated, and
c2) registers a character from the group as a registered current input character if the character was displayed for at least a predetermined period of time before the key is further operated.

2. The HMI device as claimed in claim 1, wherein, during a sequence of operations of the key of the keypad, the processing unit additionally brings the group of the assigned keys to display on the display element.

3. The HMI device as claimed in claim 2, wherein the processing unit displays the different character from the group of the assigned characters and corresponding to the current number of times the key is operated as a highlighted character.

4. The HMI device as claimed in claim 1, wherein the keypad is configured as a keypad of a mobile communication device.

5. The HMI device as claimed in claim 4, wherein the keypad is configured as a keypad of a cell phone.

6. The HMI device as claimed in claim 1, wherein the display element comprises a touchscreen and the keypad comprises a virtual keypad displayed on the touchscreen.

7. The HMI device as claimed in claim 1, wherein the process variables comprise setpoint values of controlled variables and editable messages of the industrial process.

8. An HMI device for observing and operating an industrial process, comprising:
a) a display element at least for process variables,
b) at least one keypad, whereby keys of the keypad are each assigned a respective group of characters, and
c) a processing unit comprising:
c1) at least one text index and
c2) a text analyzer programmed to check, on operation of a key of the keypad, the characters from the assigned respective group together with any associated, previously entered input characters for at least partial matches with entries in the text index, and to output stored entries having a high degree of correspondence as a possible string of input characters on the display element.

9. The HMI device as claimed in claim 8, wherein the text index is matched with terms utilized in a predetermine industrial installation or a predetermined type of installation.

10. The HMI device as claimed in claim 8, wherein the keypad is configured as a keypad of a mobile communication device.

11. The HMI device as claimed in claim 10, wherein the keypad is configured as a keypad of a cell phone.

12. The HMI device as claimed in claim 8, wherein the display element comprises a touchscreen and the keypad comprises a virtual keypad displayed on the touch screen.

13. An automation system which acts on an industrial facility and which comprises:
at least one HMI device for observation and operation of an industrial process of the industrial facility, comprising:
a) a display element at least for process variables,
b) at least one keypad, a group of characters being assigned to a key of the keypad, and
c) a processing unit, which:
c1) displays a different character from the group of the assigned characters on the display element in a process variable each time the key of the keypad is operated, and
c2) registers a character from the group as a registered current input character if the character was displayed for at least a predetermined period of time before the key is further operated.

14. The automation system as claimed in claim 12, wherein the processing unit of the HMI device comprises:
at least one text index and
a text analyzer programmed to check, on operation of a key of the keypad, the characters from the assigned respective group together with any associated, previously entered input characters for at least partial matches with entries in the text index, and to output stored entries having a high degree of correspondence as a possible string of input characters on the display element.
